(19) United States
(12) Patent Application Publication
(10) Pub. No.: US 2016/0193827 A1
(43) Pub. Date: Jul. 7, 2016

(54) PLANOGRAPHIC PRINTING SYSTEM AND A PLANOGRAPHIC PRINTING METHOD

(71) Applicant: Institute of Chemistry, Chinese Academy of Sciences, Beijing (CN)

(72) Inventors: Yanlin SONG, Beijing (CN); Ming YANG, Beijing (CN); Wei WU, Beijing (CN); Yunxia LIU, Beijing (CN); Jiancheng PAN, Beijing (CN)

(73) Assignee: Institute of Chemistry, Chinese Academy of Sciences, Beijing (CN)

(21) Appl. No.: 14/988,153

(22) Filed: Jan. 5, 2016

(30) Foreign Application Priority Data
Jan. 5, 2015 (CN) 201510002353.X

(51) Int. Cl. B41F 31/00; B41F 7/20; B41F 13/08

(52) U.S. Cl. CPC B41F 31/00; B41F 13/08; B41F 7/20

(57) ABSTRACT

A planographic printing system and method. The planographic printing system comprises an ink supply device, a planographic printing plate and a printing stock, the planographic printing plate gains ink from the ink supply device, so as to transfer graphic-text information from the planographic printing plate to surface of the printing stock, the planographic printing plate comprises a substrate, an ink repulsive layer attaching to the surface of the substrate and a graphic-text layer attaching to partial surface of the ink repulsive layer, the ink repulsive layer comprises fluoropolymer and silicon-containing nano-particle dispersed in the fluoropolymer, the fluoropolymer comprises fluorine-containing structural unit and optional acrylate-based structural unit. The present invention may achieve a graphic-text area which is affinity to water-based printing ink and a blank area which is repulsion to water-based printing ink on the surface of the printing plate by using water-based printing ink only without water or fountain solution.

### CROSS REFERENCE TO RELATED APPLICATION

This application claims priority to Chinese Patent Application No. 201510002353.X, which was filed on Jan. 5, 2015, and is incorporated herein by reference as if fully set forth.

### FIELD OF INVENTION

The present invention relates to a planographic printing system and a planographic printing method, particularly to a planographic printing system and a planographic printing method adopting water-based printing ink for printing.

### BACKGROUND

Planographic printing is evolved from earlier lithography. Term of “planographic printing” refers to a mode of printing by the method that there is no height difference between printing part and non-printing part, in other words, both printing part and non-printing part are on a level, and the principle of incompatibility between water and oil is applied to make the image part maintain an oil film rich in oil, while the non-printing part may absorb an appropriate amount of water, when oil is applied on the plate, the image part will repulse water but absorb ink, the non-printing part will absorb water to form an anti-ink effect. Planographic printing is one of the main printing methods at present and also is the most widely applied printing method.

Compared to other printing methods (such as, intaglio printing, letterpress printing and screen printing), the planographic printing has advantages of low platemaking cost and high printing accuracy. Unlike intaglio printing, letterpress printing and other traditional printing technologies, the blank part and the graphic-text part of the printing plate in planographic printing are almost on a level, and an oleophylic hydrophobic graphic-text part and a hydrophilic oleophobic blank part are formed on the same level of the printing plate by the principle of water-oil repulsion; and during printing, the printing plate is moistened with “water” at first before ink is applied, through transfer by a rubber blanket, prints are thus formed on the stock for printing. With the evolution of technology, “waterless offset printing” as a planographic printing method is emerged, in which “water” is not needed for protection of the blank area during printing, and ink alone forms an oleophylic graphic-text area and an oleophobic blank area on the same level of the printing plate.

However, both the conventional planographic printing applying the theory of “oil-water separation” and the new-style “waterless offset printing” unavoidably need solvent-based ink. By now, the printing methods such as intaglio printing, flexographic printing etc in the printing field may use environment friendly water-based printing ink for printing, while planographic printing is unable to adopt water-based printing ink due to the restriction of its printing theory.

### SUMMARY

The object of the present invention is to overcome the technical problem that the current planographic printing plates cannot adopt water-based printing ink for printing and intends to provide a planographic printing system as well as a planographic printing method, which can adopt environment friendly water-based printing ink for printing.

According to the first aspect of the present invention, the present invention provides a planographic printing system, comprising an ink supply device, a planographic printing plate and a printing stock, the planographic printing plate gains ink from the ink supply device, so as to transfer graphic-text information from the planographic printing plate to surface of the printing stock, the planographic printing plate comprises a substrate, an ink repulsive layer attaching to the surface of the substrate and a graphic-text layer attaching to partial surface of the ink repulsive layer, the ink repulsive layer comprises fluoropolymer and silicon-containing nano-particle dispersed in the fluoropolymer, the fluoropolymer comprises fluorine-containing structural unit and optional acrylate-based structural unit.

According to the second aspect of the present invention, the present invention provides a planographic printing method, which is performed in a planographic printing system, the planographic printing system comprises an ink supply device, a planographic printing plate and a printing stock, the planographic printing plate comprises a substrate, an ink repulsive layer attaching to at least one surface of the substrate and a graphic-text layer attaching to partial surface of the ink repulsive layer, the ink repulsive layer comprises fluoropolymer and silicon-containing nano-particle dispersed in the fluoropolymer, the fluoropolymer comprises fluorine-containing structural unit and optional acrylate-based structural unit, the method comprises delivering water-based printing ink to the planographic printing plate through the ink supply device, and transferring graphic-text information on the graphic-text layer of the planographic printing plate to the surface of the printing stock.

The present invention breaks through the concept that conventional planographic printing applies “the principle of oil-water repulsion”, but constitutes a graphic-text area which is affinity to water-based printing ink and an area without graphic-text which is repulsion to water-based printing ink on the surface of the planographic printing plate, thus the restriction that a conventional planographic printing plate must rely on water or “fountain solution” to occupy the blank area without graphic-text is spurned, and the present invention may achieve a graphic-text area which is affinity to water-based printing ink and a blank area which is repulsion to water-based printing ink on the surface of the printing plate by using water-based printing ink only without using water or fountain solution, and then transfers the water-based printing ink to the surface of the printing stock, thereby forming a printing pattern on the surface of the printing stock.

The printing plate according to the present invention has desirable pressrun and the presswork obtained by using the printing plate has high resolution.

### BRIEF DESCRIPTION OF THE DRAWINGS

The accompanying drawings are intended to provide further understanding on the present invention, which constitute a part of the specification and explain the present invention together with the following embodiments, but they do not constitute a limitation to the present invention.

FIG. 1 exemplarily describes the planographic printing plate in the planographic printing system according to the present invention.

FIG. 2 exemplarily describes the planographic printing system of the present invention.

FIG. 3 is space diagram of the planographic printing system shown in FIG. 2.

### DETAILED DESCRIPTION OF THE PREFERRED EMBODIMENTS

Hereinafter, the embodiments of the present invention will be described in details by referring to the accompanying drawings. It should be understood that the embodiments described herein are intended to describe and explain the present invention only, and not to limit the scope of the present invention.

According to the first aspect of the present invention, the present invention provides a planographic printing system, comprising an ink supply device, a planographic printing plate and a printing stock, the planographic printing plate gains ink from the ink supply device, so as to transfer graphic-text information from the planographic printing plate to surface of the printing stock.

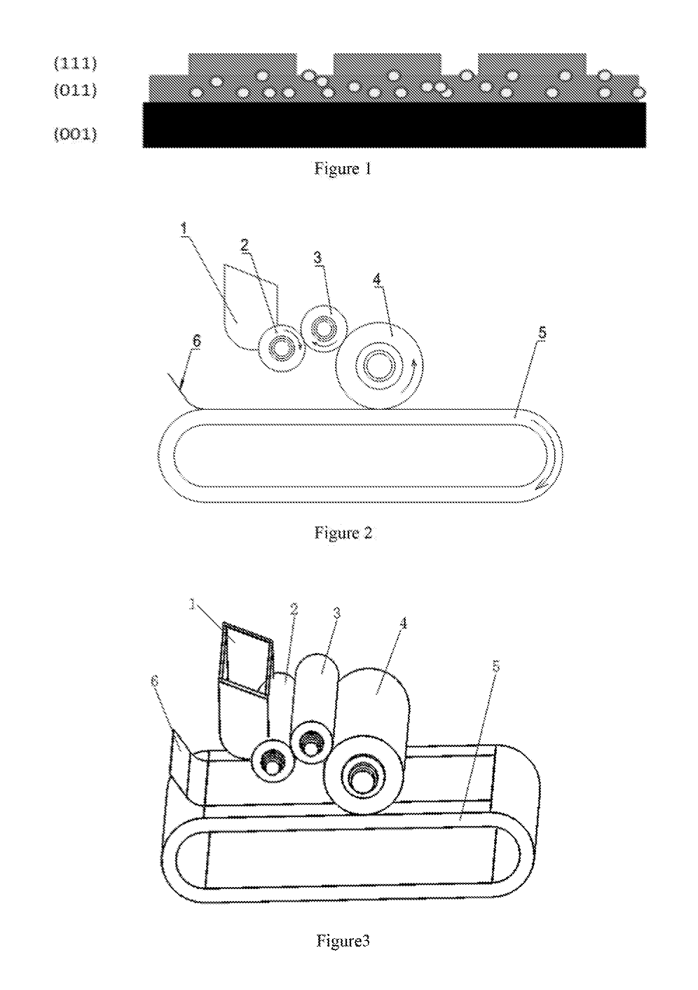

According to the first aspect of the present invention, as shown in FIG. 1, the planographic printing plate comprises a substrate 001, an ink repulsive layer 011 attaching to at least one surface of the substrate 001 and a graphic-text layer 111 attaching to partial surface of the ink repulsive layer 011.

The ink repulsive layer comprises fluoropolymer and silicon-containing nano-particle dispersed in the fluoropolymer.

The fluoropolymer refers to the polymer containing fluorine atom in the polymer chain. The fluoropolymer may contain fluorine-containing structural unit only or a combination of fluorine-containing structural unit and structural unit containing no fluorine atom.

The fluorine-containing structural unit is structural unit containing fluorine atom. The fluorine-containing structural unit may be derived from fluorine-containing monomer containing ethylenically unsaturated double bond. The fluorine-containing monomer containing ethylenically unsaturated double bond may be at least one selected from the group consisting of fluoroacrylate-based monomer, fluoroacrylamide-based monomer, fluoro sulfonamido acrylate-based monomer, fluorohydrocarbyl-substituted styrene, N-allyl-perfluoro hydrocarbyl-sulfamide, allyl-fluorohydrocarbyl ether and fluorohydrocarbyl styryl ether.

Specifically, the fluorine-containing monomer containing ethylenically unsaturated double bond may be at least one selected from the group consisting of perfluoroalkyl (meth)acrylate, perfluoroamido alkyl (meth)acrylate, perfluorosulfonamido alkyl (meth)acrylate, fluoroalkyl-substituted styrene, fluoroalkyl-alkenyloxy-styrene, N-allyl-perfluoroalkyl-sulfamide and allyl perfluoroalkyl-alkenyl ether. In the context, the term of “(meth)acrylate” includes acrylate and methacrylate.

The specific example of the perfluoroalkyl (meth)acrylate may include but is not limit to perfluoroethyl (meth)acrylate, perfluoropropyl (meth)acrylate, perfluoromethyl (meth)acrylate, perfluorobutyl (meth)acrylate, perfluoroamyl (meth)acrylate, perfluorohexyl (meth)acrylate, perfluoroheptyl (meth)acrylate, perfluorooctyl (meth)acrylate, perfluorononyl (meth)acrylate, perfluorodecyl (meth)acrylate, perfluorohendecyl (meth)acrylate and perfluorododecyl (meth)acrylate.

The specific example of the perfluoro-amido alkyl (meth)acrylate may include but is not limit to (N-methyl-perfluorohexyl-amido)ethyl acrylate, (N-methyl-perfluorooctyl-amido)ethyl acrylate and (N-methyl-perfluoroheptyl-amido)ethyl acrylate.

The specific example of the perfluoro-sulfonamido alkyl (meth)acrylate may include but is not limit to (N-methyl-perfluorohexyl-sulfonamido)ethyl acrylate, (N-methyl-perfluorooctyl-sulfonamido)ethyl acrylate and (N-methyl-perfluoroheptyl-sulfonamido)ethyl acrylate.

The fluorohydrocarbyl group in fluorohydrocarbyl-substituted styrene may be in ortho-position, meta-position or para-position of the phenyl ring relative to ethenyl. The quantity of fluorohydrocarbyl group in fluorohydrocarbyl-substituted styrene may be one or more. The specific example of the fluorohydrocarbyl-substituted styrene may include but is not limit to 4-trifluoromethyl styrene, 2-trifluoromethyl styrene, 3-trifluoromethyl styrene, 4-perfluoroethyl styrene, 4-perfluoropropyl styrene and 4-perfluorobutyl styrene.

Fluoroalkyl-alkenyloxy group of the fluoroalkyl-alkenyloxy-styrene may be in ortho-position, meta-position or para-position of the phenyl ring relative to ethenyl. The amount of fluoroalkyl-alkenyloxy group may be one or more. The specific example of the fluoroalkyl-alkenyloxy-styrene may include but is not limit to 4-perfluoro(2-isopropyl-1,3-dimethyl-1-butenyl)oxy styrene.

The specific example of the N-allyl-perfluoroalkyl-sulfamide may include but is not limit to N-allyl-perfluoromethyl-sulfamide, N-allyl-perfluoroethyl-sulfamide and N-allyl-perfluorobutyl-sulfamide.

The specific example of the allyl perfluoroalkyl-alkenyl ether may include but is not limit to allyl perfluoro(2-isopropyl-1,3-dimethyl-1-butenyl) ether.

Preferably, the fluorine-containing monomer containing ethylenically unsaturated double bond is at least one selected from the group consisting of C₁-C₃ perfluoroalkyl (meth)acrylate, 4-perfluoro(2-isopropyl-1,3-dimethyl-1-butenyl)oxy styrene and N-allyl-perfluorobutyl-sulfamide.

The structural unit containing no fluorine refers to the structural unit not containing fluorine atom in the molecular structure. Preferably, the structural unit containing no fluorine is acrylate-based structural unit and may be derived from acrylate-based monomer. The acrylate-based monomer specifically may be at least one selected from the group consisting of compounds shown in formula I,

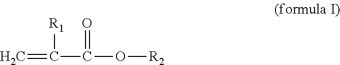

in formula I, R₁ is hydrogen or C₁-C₃ alkyl, R₂ is C₁-C₁₂ alkyl, C₆-C₁₂ phenyl, C₇-C₁₂ phenyl alkyl, —R₃—O—R₄, isobornyl or norbornyl, R₃ is C₁-C₆ alkylene, and R₄ is C₁-C₁₂ alkyl.

Specifically, the acrylate-based monomer may be at least one selected from the group consisting of methyl methacrylate, ethyl methacrylate, propyl methacrylate, butyl methacrylate, isobutyl methacrylate, amyl methacrylate, hexyl methacrylate, 2-ethyl-hexyl methacrylate, nonyl methacrylate, decyl methacrylate, dodecyl methacrylate, phenyl methacrylate, benzyl methacrylate, ethyoxy-methyl methacrylate, methoxy-ethyl methacrylate (such as 1-methoxy-ethyl methacrylate, 2-methoxy-ethyl methacrylate), propoxy-ethyl methacrylate (such as 1-propoxy-ethyl methacrylate, 2-propoxy-ethyl methacrylate), butoxy-ethyl methacrylate (such as 1-butoxy-ethyl methacrylate, 2-butoxy-ethyl methacrylate), ethoxy-propyl methacrylate (such as 1-ethoxy-propyl methacrylate, 2-ethoxy-propyl methacrylate, 3-ethoxy-propyl methacrylate) and isobornyl methacrylate.

In the planographic printing plate according to the present invention, based on the fluoropolymer, the fluorine-containing structural unit may be in a content of 50-100% by weight, preferably 55-100% by weight, more preferably 60-90% by weight, still more preferably 60-85% by weight; the acrylate-based structural unit may be in a content of 0-50% by weight, preferably 0-45% by weight, more preferably 10-40% by weight, still more preferably 15-40% by weight. The content of the fluorine-containing structural unit and the optional acrylate-based structural unit may be measured by nuclear magnetic resonance spectroscopy, or be calculated by the addition amount of the monomer.

The planographic printing system according to the present invention, in a preferred embodiment, the fluorine-containing structural unit in the fluoropolymer is derived from at least one monomer selected from the group consisting of fluorohydrocarbyl-substituted styrene, N-ally perfluorohydrocarbyl sulfamide, ally fluorohydrocarbyl ether and fluorohydrocarbyl styryl ether. According to the preferred embodiment, the printing plate has higher pressrun under the precondition that the presswork printed by this printing plate has higher graphic-text resolution. More preferably, the fluorine-containing structural unit in the fluoropolymer is derived from fluorohydrocarbyl styryl ether. Still more preferably, the fluorine-containing structural unit in the fluoropolymer is derived from fluoroalkyl-alkenyloxy-styrene. In a specific preferable embodiment, the fluorine-containing structural unit is derived from 4-perfluoro(2-isopropyl-1,3-dimethyl-1-butenyl)oxy styrene. In the preferred embodiment, from the perspective of further improving pressrun of the printing plate, the fluoropolymer preferably also contains acrylate-based structural unit. Based the fluoropolymer, the acrylate-based structural unit may be in a content of 30-40% by weight. The acrylate-based structural unit may be the acrylate-based structural unit as mentioned above, preferably is derived from alkyl methacrylate, more preferably is derived from C₁-C₅ alkyl methacrylate, still more preferably is derived from C₁-C₃ alkyl methacrylate.

According to planographic printing system provided by the present invention, the ink repulsive layer comprises silicon-containing nano-particle. The silicon-containing nano-particle refers to nano-particle containing silicon atom. The specific example of the silicon-containing nano-particle may include but is not limited to silica, silicon nitride and silicon carbide. The silica may be fumed silica. The silicon-containing nano-particle may have a particle size in range of 10 nm to 200 nm. In the context, the particle size refers to volume average particle size and is determined by laser particle size analyzer.

The silicon-containing nano-particle has effects of raise surface roughness of the ink repulsive layer and the hydrophobicity (i.e., lipophilicity) of the surface of the ink repulsive layer. The silicon-containing nano-particle in the ink repulsive layer may be in a content enough to realize the above effect. Generally, relative to 100 parts of fluoropolymer, the silicon-containing nano-particle may be in a content of 1-150 parts by weight, preferably 2-80 parts by weight, more preferably 4-30 parts by weight.

Preferably, surface of the silicon-containing nano-particle is modified by coupling agent. The coupling agent may be a coupling agent, which can not only take chemical and/or physical interaction with the surface group (such as hydroxyl) of silicon-containing nano-particle but also take chemical and/or physical interaction with the group in the molecular structure of fluoropolymer. Preferably, the coupling agent is silane coupling agent. More preferably, the coupling agent is at least one selected from the group consisting of vinyl triethoxy silane, vinyl trimethoxy silane, vinyl tri(β-methoxyethoxy) silane, γ-aminopropyltrimethoxy silane, γ-aminopropyltriethoxy silane, 3-glycidoxy propyl trimethoxy silane, γ-(methylacryloyloxy) propyltrimethoxy silane, γ-mercaptopropyl triethoxy silane and N-(β-aminoethyl)-γ-aminopropyltriethoxy silane.

According to the planographic printing system provided by the present invention, the ink repulsive layer may be coated on the surface of the substrate in a routine amount. Preferably, ink repulsive layer may be in a coating amount of 2-5 g·m⁻², preferably 2.4-4 g·m⁻².

According to the planographic printing system provided by present invention, the ink repulsive layer preferably has a surface energy in range of 15-40 J·m⁻². When the surface energy of the ink repulsive layer is in this range, the presswork printed by this printing plate has higher quality and can form graphic-text information with higher quality. More preferably, the ink repulsive layer has a surface energy in range of 20-30 J·m⁻². In the present invention, surface energy is determined by contact angle method (referring to Measure Surface Energy of Polymer Materials by Contact Angle Method, Wang Hui, Gu Jinhua and Qiu Guanzhou, Journal of Central South University (Natural Sciences), Issue 5, 2006).

According to the planographic printing system provided by present invention, the ink repulsive layer preferably has a roughness Ra in range of 0.3 μm to 0.8 μm. When the roughness of the ink repulsive layer is in this range, the graphic-text layer has higher adhesive force on the surface of the ink repulsive layer and the obtained presswork has higher resolution, thereby acquiring higher graphic-text quality. More preferably, the ink repulsive layer has a roughness Ra in range of 0.35 μm to 0.6 μm. In the present invention, roughness Ra is determined by the method specified in HG-T2694-2003-positive printing PS plate.

According to the planographic printing system provided by present invention, the ink repulsive layer preferably has an elastic modulus in range of 3×10⁵N m⁻² to 10×10⁵N m⁻². When the elastic modulus of the ink repulsive layer is in this range, the pressrun of the printing plate can be raised further. More preferably, the ink repulsive layer has an elastic modulus in range of 5×10⁵N m⁻² to 7×10⁵N m⁻². The elastic modulus is determined by the method: disclosed in Method for Measuring Elastic Modulus of Coating; Cheng Yingke, Zhang Jianjun and Xu Lianyong; Science Paper Online; Issue 4, 2008.

According to the planographic printing system provided by present invention, the graphic-text layer is a hydrophilic layer and its surface energy may be a routine choice, without particular restriction.

The graphic-text layer may be formed by ink for graphic-text layer, preferably by water-based platemaking ink. In a preferred embodiment of the present invention, the water-based platemaking ink comprises water soluble phenolic resin, optional leveling agent, optional dye and water. Based on the water-based platemaking ink, the water soluble phenolic resin may be in a content of 5-60% by weight, the leveling agent may be in a content of 0-10% by weight, the dye may be in a content of 0-10% by weight and the water may be in a content of 20-95% by weight. From the perspective of further improving the pressrun and resolution of the printing plate, based on the water-based platemaking ink, the water soluble phenolic resin is preferably in a content of 10-50% be weight, more preferably in a content of 10-20% by weight; the leveling agent is preferably in a content of 0.5-5% by weight, more preferably in a content of 2-3% by weight; the dye is preferably in a content of 0-5% by weight, more preferably in a content of 1-2% by weight; and the water is preferably in a content of 40-89.5% by weight, more preferably in a content of 75-87% by weight.

The water soluble phenolic resin refers to phenolic resin which can be dissolved in water. A typical example of the water soluble phenolic resin is alkali-catalyzed phenolic resin, that is, phenolic resin containing phenolic hydroxyl in the molecular structure, for example, the water soluble phenolic resin containing phenolic hydroxyl may be obtained by reacting phenol with aldehyde (such as formaldehyde) in presence of basic catalyst.

The leveling agent is preferably organosilicone-based leveling agent. The organosilicone-based leveling agent may be at least one selected from the group consisting of polydimethylsiloxane, polymethylphenyl siloxane, polyether modified polysiloxane (copolymer of polyether and organosilicon, a specific example of which may be polyether modified polydimethylsiloxane) and polyester modified polysiloxane (for example, copolymer of polyester and organosilicon).

The dye may be a common water soluble dye, which may be selected based on color, without particular restriction. Specifically, the dye may be active dye, acidic dye or basic dye. The active dye may be black dye SP series or reactive black. The basic dye may be dye acid blue or dye acid yellow. The basic dye may be basic brilliant blue or Victoria blue. The dye acid blue may be acid blue 9, acid blue 25, acid blue 40, acid blue 62, acid blue 324, acid blue AS, acid blue AGG, acid blue 2BR or acid blue BR. The dye acid yellow may be dye acid yellow 3, dye acid yellow 23, dye acid yellow 49, dye acid yellow 127 or dye acid yellow 6G.

The graphic-text layer may be coated on the ink repulsive layer in a common coating amount. Generally, the graphic-text layer may be in a coating amount of 0.5-3 g·m⁻², preferably 0.8-2.5 g·m⁻².

According to the planographic printing system provided by the present invention, the substrate may be a common substrate, for example, the substrate may be a metal substrate or a polymer substrate. The specific example of the substrate may include but is not limited to aluminum substrate, aluminum alloy substrate, steel substrate, polycarbonate substrate, polyester substrate or polyolefin substrate.

According to the planographic printing system provided by the present invention, the surface of the substrate for forming an ink repulsive layer may be roughened or not. The roughening is to form a rough structure on the surface of the substrate. For example, when the substrate is a metal substrate, such as aluminum substrate or aluminum alloy substrate, the surface of the substrate may be subjected to anodic oxidation treatment, sand blasting treatment or paper sanding treatment in order to form a rough structure on the surface of the substrate. Preferably, the surface of the substrate for forming an ink repulsive layer is not roughened so as to shorten the technological process and avoid environmental pollutants generated from roughening treatment.

According to the planographic printing system provided by the present invention, the planographic printing plate may be prepared by a method comprising the following steps,

(1) coating fluid for the ink repulsive layer on at least one surface of the substrate and solidifying the fluid to obtain a substrate with an ink repulsive layer;

(2) applying ink for the graphic-text layer, preferably water-based platemaking ink, onto at least partial surface of the ink repulsive layer and solidifying the ink for the graphic-text layer applied on the surface of the ink repulsive layer to form the graphic-text layer on the surface of the ink repulsive layer, wherein, the fluid for the ink repulsive layer comprises the fluoropolymer and the silicon-containing nano-particle dispersed in the fluoropolymer, and the fluoropolymer comprises fluorine-containing structural unit and optional acrylate-based structural unit.

In the present invention, “solidification” means that a fluid loses fluidity and is transformed into solid material.

In step (1), the fluid for the ink repulsive layer comprises fluoropolymer and silicon-containing nano-particle dispersed in the fluoropolymer. The fluoropolymer and the silicon-containing nano-particle have been described in details hereinbefore, so the description for the same is omitted herein.

The fluid for the ink repulsive layer may further comprise a dispersing agent to evenly disperse silicon-containing nano-particle in the fluoropolymer. The dispersing agent may be selected based on the type of the fluoropolymer provided that it can dissolve the fluoropolymer. Generally, the dispersing agent is preferably a ketone-based dispersing agent. The specific example may include but is not limited to at least one selected from the group consisting of acetone, butanone, cyclohexanone and N-methyl pyrrolidone.

The content of the dispersing agent may be selected according to the amount of the fluoropolymer. Generally, relative to 100 parts by weight of the fluoropolymer, the dispersing agent may be in a content of 100-2000 parts by weight, preferably 300-1500 parts by weight.

The fluid for the ink repulsive layer may be obtained by dispersing the fluoropolymer and the silicon-containing nano-particle in the dispersing agent.

In a preferred embodiment of the present invention, the fluid for the ink repulsive layer is prepared by method I or method II as described below.

Method I includes a polymerization step and an optional coupling agent treatment step. In the coupling agent treatment step, the silicon-containing nano-particle is contacted with the silane coupling agent to react, and solid material is separated from reaction mixture to obtain silicon-containing nano-particle treated with coupling agent. In the polymerization step, under the condition of radical polymerization reaction, the fluorine-containing monomer containing ethylenically unsaturated bond and optional acrylate-based monomer contact with radical initiator to take polymerization reaction, so as to obtain the fluoropolymer; the silicon-containing nano-particle and/or the silicon-containing nano-particle treated with coupling agent is dispersed in the fluoropolymer to obtain the fluid for the ink repulsive layer.

Method II includes a polymerization step and an optional coupling agent treatment step. In the coupling agent treatment step, the silicon-containing nano-particle is contacted with the silane coupling agent to react, and solid material is separated from reaction mixture to obtain silicon-containing nano-particle treated with coupling agent. In the polymerization step, under the condition of radical polymerization reaction, and in presence of the silicon-containing nano-particle and/or the silicon-containing nano-particle treated with coupling agent, fluorine-containing monomer containing ethylenically unsaturated bond and optional acrylate-based monomer contact with radical initiator to take polymerization reaction, so as to obtain the fluid for the ink repulsive layer.

In method I and method II, the fluorine-containing monomer containing ethylenically unsaturated bond, the acrylate-based monomer and the silicon-containing nano-particle have been described in details above, so the description for the same is omitted herein.

In method I and method II, the coupling agent treatment step may be carried out or not. Preferably, the coupling agent treatment step is carried out, so as to improve the interfacial interaction between silicon-containing nano-particle and the fluoropolymer, thereby improve the compatibility between the silicon-containing nano-particle and the fluoropolymer, as a result, the printing quality and the pressrun of the printing plate can be improved.

The coupling agent may be a coupling agent, which can not only take chemical and/or physical interaction with the surface groups (such as: hydroxyl) of silicon-containing nano-particle but also take chemical and/or physical interaction with the groups in the molecular structure of fluoropolymer. Preferably, the coupling agent is silane coupling agent. More preferably, the coupling agent is at least one selected from the group consisting of vinyl triethoxy silane, vinyl trimethoxy silane, vinyl tri(β-methoxyethoxy) silane, γ-aminopropyltrimethoxy silane, γ-aminopropyltriethoxy silane, 3-glycidoxy propyl trimethoxy silane, γ-(methylacryloyloxy) propyltrimethoxy silane, γ-mercaptopropyl triethoxy silane and N-(β-aminoethyl)-γ-aminopropyltriethoxy silane.

The content of the coupling agent may be selected based on the amount of silicon-containing nano-particle. Generally, relative to 100 parts by weight of the silicon-containing nano-particle, the coupling agent may be in a content of 5-500 parts by weight, preferably in a content of 80-400 parts by weight, more preferably in a content of 250-350 parts by weight.

In the coupling agent treatment step of method I and method II, a conventional method may be adopted to take chemical and/or physical interaction between the coupling agent and silicon-containing nano-particle. In an embodiment of the present invention, a dispersion solution comprising the silicon-containing nano-particle and the silane coupling agent is subjected to ultrasonically treated, solid material is separated from the ultrasonically treated dispersion solution, and the obtained solid material is optionally subjected to drying, thereby obtaining the silicon-containing nano-particle treated with coupling agent. The dispersion medium of the dispersion solution may be a regular choice, such as ketone-based dispersing medium. The specific example for the dispersing medium may include but is not limited to at least one selected from the group consisting of acetone, butanone, cyclohexanone and N-methyl pyrrolidone. The condition for ultrasonic treatment may be a regular choice. Generally, the ultrasonic frequency may be in range of 20-200 kHz, preferably in range of 50-100 kHz. The duration period of the ultrasonic treatment may be in range of 10-30 min. The drying may be carried out at a temperature of 80-220° C., preferably at a temperature of 150-200° C. The duration period of drying may be selected according to the temperature of drying. Generally, the duration period of the drying may be in range of 2-4 h.

In the polymerization step of method I and method II, the radical initiator may be an initiator which is enough to initiate radical polymerization between the fluorine-containing monomer and optional acrylate-based monomer. Specifically, the radical initiator may be at least one selected from the group consisting of azo-based radical initiator and organic peroxy initiator. The specific example of the radical initiator may include but is not limited to azodiisobutyronitrile, azobisisoheptonitrile, dibenzoyl peroxide, di-tert-butyl peroxide and dodecamoyl peroxide. Preferably, the radical initiator is azo-based initiator.

The content of the radical initiator may be selected according to the expected polymer molecular weight. Generally, relative to 100 parts by weight of monomer (including fluorine-containing monomer and acrylate-based monomer), the radical initiator may be in a content of 1-30 parts by weight, preferably in a content of 1.5-20 parts by weight.

In the polymerization step of method I and method II, the polymerization may be taken in a conventional solvent. The solvent may be a ketone-based solvent. The specific example of the solvent may include but is not limited to at least one selected from the group consisting of acetone, butanone, cyclohexanone and N-methyl pyrrolidone. The solvent may be used in common amount. Generally, relative to 100 parts by weight of monomer (including fluorine-containing monomer and acrylate-based monomer), the solvent may be in a content of 100-2000 parts by weight, preferably in a content of 300-1500 parts by weight.

In the polymerization step of method I and method II, the polymerization may take place at a temperature enough to make the radical initiator decomposed to generate free radicals and initiate monomer to take polymerization. In general, the polymerization may be conducted at a temperature of 50-80° C. In method I, the polymerization is preferably conducted at a temperature of 60-70° C. In method II, the polymerization is preferably conducted at a temperature of 50-65° C. In method I and method II, the duration period of polymerization may be in range of 10-40 h, preferably in range of 12-36 h.

The main difference between method II and method I is that in method II, polymerization is conducted in presence of the silicon-containing nano-particle and/or silicon-containing nano-particle treated with coupling agent.

In method II, silicon-containing nano-particle and/or silicon-containing nano-particle treated with coupling agent as well as monomer may be dispersed in a solvent, and then the dispersion solution is subjected to polymerization reaction. In method I, silicon-containing nano-particle and/or the silicon-containing nano-particle treated with coupling agent may be dispersed in the reaction solution obtained from the polymerization after the polymerization is completed. In method I, the dispersion may be carried out under the condition of ultrasonic treatment to improve dispersion effect and shorten duration period for dispersion.

In method II, the reaction mixture obtained from polymerization may be directly used as the fluid for the ink repulsive layer, so as to from an ink repulsive layer on the surface of the substrate. In method I, the polymerization reaction solution containing dispersed silicon-containing nano-particle and/or silicon-containing nano-particle treated with coupling agent may be directly used as the fluid for the ink repulsive layer, so as to form an ink repulsive layer on the surface of the substrate.

In step (1), when an aluminum substrate is used, it is typically subjected to a treatment of deoiling before use. A conventional deoiling method may be adopted. In an embodiment, a deoiling treatment may comprise the step of soaking the aluminum substrate in alkaline solution in a concentration of 0.5% to 20% by weight for 10 s to 200 s. The alkaline material in the alkaline solution may be a conventional alkaline material, and the specific example may include but is not limited to at least one selected from the group consisting of sodium hydroxide, sodium carbonate, sodium bicarbonate, sodium phosphate and monosodium phosphate.

In step (2), a conventional method may be adopted to apply the ink for the graphic-text layer onto at least partial surface of the ink repulsive layer. Preferably, an ink-jet printing method is adopted to apply the ink for the graphic-text layer onto the surface of the ink repulsive layer, so as to form graphic-text information. The ink for the graphic-text layer is preferably water-based platemaking ink. The water-based platemaking ink and its composition have been described in details hereinbefore, so the description for the same is omitted herein.

In step (1) and (2), the solidification may be respectively conducted at a temperature of 120-200° C. In step (1), the duration period of the solidification may be in range of 2-30 min. In step (2), the duration period of the solidification may be in range of 10-30 min.

The planographic printing system according to the present invention preferably further comprises a rolling platform for supporting the printing stock. The rolling platform may be any ordinary platform, which can support the printing stock and deliver the printing stock to a position contactable with the planographic printing plate. A regular method may be adopted to make the platform roll without particular restriction.

Preferably, the rolling platform has one or two selected from the group consisting of heating part and adsorption part.

The heating part is used to heat the printing stock received ink, so as to dry the ink on the surface of the printing stock. The heating part may be any ordinary part, which can realize heating function. For example, the heating part may be a heater strip, which directly converts electric energy into thermal energy, or a heat medium make use of the sensible heat and latent heat carried by itself to exchange heat with the printing stock and thus heat the printing stock, such as hot water and/or hot oil. The heating degree of the heating part may be selected according to the properties of the printing ink adopted during printing on the principle of enough to dry the printing ink quickly.

The adsorption part is used to fix the printing stock to the surface of rolling platform and is particularly applicable to the occasion where the printing stock is a single piece of paper or a roll of paper. The adsorption of the adsorption part can effectively fix the printing stock to the surface of the rolling platform. The adsorption part may be any ordinary part, which can fix the printing stock to the surface of the rolling platform through adsorption. Specially, the adsorption part may be metal platform or rubber platform with function of adsorption through negative pressure adsorption, vacuum adsorption, magnetic adsorption or the combination of two or more.

The planographic printing system according to the present invention preferably further comprises a plate cylinder, the planographic printing plate is placed on the periphery of the plate cylinder. The rotation of the plate cylinder can drive the planographic printing plate to move circularly relative to the printing stock, thereby continuously transferring the graphic-text information on the surface of the planographic printing plate to the surface of the printing stock.

The plate cylinder may be any ordinary tubular object, which can fix the planographic printing plate and rotate. In general, the printing cylinder comprises a spindle and a barrel connected to the spindle in a fixed manner. The spindle may be further connected to a motor, thereby driving the spindle to rotate and further drive the barrel and the planographic printing plate fixed on the periphery of the barrel to rotate.

The plate cylinder preferably further has a temperature control part, which measures the temperature of the planographic printing plate, and heats or cools the planographic printing plate based on the measured temperature, thereby regulating the temperature on the surface of the planographic printing plate to make it meet the requirements of the printing ink. The temperature control part may specifically comprise a temperature sensor and a heating/cooling element. The temperature sensor is used to detect the temperature of the planographic printing plate and control the operating state of the heating/cooling element according to the measured temperature. The operating state of the heating/cooling element may include a heating state and a cooling state. When the temperature measured by temperature sensor is higher than the set value, the operating state of the heating/cooling element is set to be a cooling state; when the temperature measured by temperature sensor is lower than the set value, the operating state of the heating/cooling element is set to be a heating state. The heating/cooling element may adopt a heat-exchanging medium to realize the operating states of heating and cooling. The heat-exchanging medium may be water for example.

In the planographic printing system according to the present invention, the ink supply device is used to transfer ink to the planographic printing plate, thereby realizing printing. The ink supply device may be any ordinary device, which can realize ink supply. In an embodiment of the present invention, the ink supply device comprises an ink storage part and an ink transfer part. The ink storage part is used to store ink. The ink transfer part is used to transfer ink from the ink storage part to the planographic printing plate. The ink storage part may be any container, which can accommodate ink. The ink transfer part may be one or more than two roller. The roller is preferably a rubber roller. The rubber roller is a roller-shaped product comprising a metal core and vulcanized rubber peripherally covering the core. In an embodiment of the present invention, the ink transfer part comprises mutually matched plain rubber roller and anilox roller, the plain rubber roller is used to receive the ink output by the ink storage part and transfer ink to the anilox roller, the anilox roller further transfers ink to the surface of the planographic printing plate and forms an ink film on the surface of the graphic-text area, thereby transferring the graphic-text information on the surface of the planographic printing plate to the surface of the printing stock.

According to the second aspect of the present invention, the present invention provides a planographic printing method, which is performed in the planographic printing system as described in the first aspect of the prevent invention, and comprises delivering water-based printing ink to the planographic printing plate through the ink supply device, and transferring graphic-text information on the graphic-text layer of the planographic printing plate to the surface of the printing stock.

In the planographic printing method according to the present invention, the planographic printing system has been described in details hereinbefore, so the description of the same is omitted herein.

In the planographic printing method according to the present invention, the water-based printing ink may be any ordinary ink using water as a dispersion medium.

In a preferred embodiment of the present invention, the water-based printing ink comprises water-soluble hyperbranched polymer, filler, dye and water, based on the water-based printing ink, the water-soluble hyperbranched polymer may be in a content of 30-85% by weight, preferably in a content of 60-80% by weight; the filler may be in a content of 2-20% by weight, preferably in a content of 5-10% by weight; the dye may be in a content of 5-20% by weight, preferably in a content of 10-15% by weight; and the water may be in a content of 1-15% by weight, preferably in a content of 2-10% by weight.

The water-soluble hyperbranched polymer is a hyperbranched polymer soluble in water. Preferably, the water-soluble hyperbranched polymer is at least one selected from the group consisting of hyperbranched methylol phenol, hyperbranched hydroxy epoxide and hyperbranched polyamide.

The hyperbranched methylol phenol may have a number average molecular weight in range of 1000-50000, preferably in range of 1000-10000, more preferably in range of 1000-5000, still more preferably in range of 1000-3000, and a degree of branching in range of 10-90%, preferably in range of 30-80%, more preferably in range of 50-80%, still more preferably in range of 70-80%. In the present invention, the number average molecular weight is determined by gel permeation chromatography (GPC) by using monodispersed polystyrene as a standard sample, wherein, tetrahydrofuran is used as a solvent and the column temperature is set at 35° C. In the present invention, the degree of branching is determined by H-NMR.

The hyperbranched methylol phenol may specifically be the material obtained from self-condensation reaction of 2,6-dimethylol phenol in presence of basic catalyst. The specific example of the basic catalyst may include but is not limited to ammonium hydroxide. The ammonium hydroxide may be in a concentration of 5-30% by weight, preferably in a concentration of 10-25% by weight. The basic catalyst may be used in an amount enough to realize catalytic effect, and may be in a catalytic amount. Generally, relative to 100 parts by weight of the 2,6-dimethylol phenol, the basic catalyst may be used in an amount of 2 parts to 15 parts by weight, preferably in an amount of 6 parts to 10 parts by weight. The reaction may be conducted at a temperature of 40-80° C., preferably at a temperature of 50-70° C. The duration period of the reaction may be in range of 2-10 h, preferably in range of 4-8 h. The reaction may be conducted in a regular solvent, for example alcohol, preferably C₂-C₄ alcohol.

The hyperbranched polyhydroxy epoxide may have a number average molecular weight in range of 1000-100000, preferably in range of 1500-50000, more preferably in range of 1500-20000, still more preferably in range of 2000-3000, and a degree of branching in range of 10-90%, preferably in range of 30-80%, more preferably in range of 40-60%.

The hyperbranched polyhydroxy epoxide may be specifically a material formed from self-condensation reaction of the compound as shown in formula II in presence of basic catalyst,

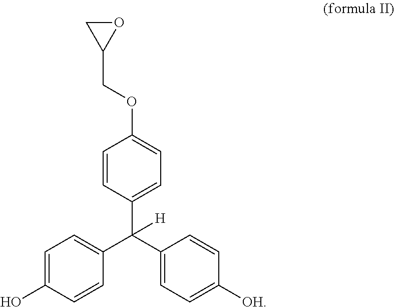 [SMILES: Oc1ccc(C(c2ccc(O)cc2)c2ccc(OCC3CO3)cc2)cc1]

The specific example of the basic catalyst may include but is not limited to alkali metal hydroxide, preferably sodium hydroxide. The alkali metal hydroxide is preferably provided in form of aqueous solution. The aqueous solution may be in a concentration of 1-10% by weight, preferably in a concentration of 1-5% by weight. The basic catalyst may be used in an amount enough to realize catalytic effect, and may be in a catalytic amount. Generally, relative to 100 parts by weight of the material as shown in formula II, the basic catalyst may be used in an amount of 5 parts to 20 parts by weight, preferably in an amount of 8 parts to 12 parts by weight. The reaction may be conducted at a temperature of 40-80° C., preferably at a temperature of 50-70° C. The duration period of the reaction may be in range of 2-10 h, preferably in range of 4-6 h. The reaction may be conducted in a regular solvent, for example alcohol, preferably C₂-C₄ alcohol.

The hyperbranched polyamide may have a number average molecular weight in range of 1000-50000, preferably in range of 1000-10000, more preferably in range of 1000-5000, still more preferably in range of 1000-2000, and a degree of branching in range of 10-90%, preferably in range of 30-85%, more preferably in range of 60-80%.

The hyperbranched polyamide may specifically be a material formed from self-condensation reaction of 4,5-dicarboxy aniline

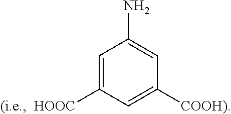

The reaction may be conducted at a temperature of 40-80° C., preferably at a temperature of 50-60° C. The duration period of the reaction may be in range of 2-8 h, preferably in range of 4-6 h. The reaction may be conducted in a regular solvent, for example alcohol, preferably C₂-C₄ alcohol.

The filler preferably is at least one selected from the group consisting of nano silica, nano calcium carbonate and nano magnesium silicate. The filler may have a particle size in range of 10-800 nm, preferably in range of 20-100 nm.

The dye is organic dye, that is, the dye made from organic compounds.

A preferred embodiment of the planographic printing system according to the present invention is shown in FIG. 2 and FIG. 3. The planographic printing system of the present invention as well as the planographic printing method adopting this system is described in detail by referring to FIG. 2 and FIG. 3 hereinafter.

As shown in FIG. 2 and FIG. 3, the planographic printing system comprises an ink fountain 1 for accommodating water-based printing ink, a plain rubber roller 2 and an anilox roller 3 for transferring water-based printing ink, a plate cylinder 4 for mounting the printing plate, and a rolling platform 5 for fixing the printing stock. The plate cylinder 4 has a temperature control part. The rolling platform 5 has a heating part and an adsorption part. The ink fountain 1, the ink fountain rubber roller 2, the anilox roller 3 and the plate cylinder 4 are disposed on the rolling platform 5 from left to right in turn; the planographic printing plate is placed on the periphery of the plate cylinder 4.

Upon printing, the water-based printing ink contained in the ink fountain 1 is transferred to anilox roller 3 through the plain rubber roller 2 and quantitatively transferred via anilox roller 3 to the surface of the planographic printing plate placed on the periphery of plate cylinder 4. The graphic-text part of the planographic printing plate accepts water-based printing ink, the blank part repels water-based printing ink and the water-based printing ink accepted by the graphic-text part is transferred to the surface of printing stock 6, thereby forming graphic-text information on the surface of printing stock 6. Through heating by the heating part in rolling platform 5, the water-based printing ink on the surface of printing stock 6 is quickly dried to complete printing.

Below the present invention is described in details by referring to Examples, without limit the scope of the present invention.

Preparation Examples 1 to 24 are used to prepare the planographic printing plate according to the present application.

### Preparation Example 1

An aluminum plate is used as a substrate, which is not subject to roughening, but before use, it is subject to deoiling by soaking in 5% by weight sodium hydroxide aqueous solution for 60 s, rinsing with water and then drying.

The fluid for the ink repulsive layer is applied by spin coater on one surface of the substrate at a speed of 4500 rpm in a coating amount of 2.5 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1 g·m⁻² followed by solidified in air at 150° C. for 20 min to obtain the printing plate according to the present invention.

Wherein, the fluid for the ink repulsive layer is prepared by adding 1 g of perfluoroethyl acrylate and 0.2 g of propyl methacrylate in a three-neck flask under the protection of nitrogen, then adding 12 g of butanone and 0.05 g of azodiisobutyronitrile and taking reaction in nitrogen at 60° C. for 12 h; finally adding 0.05 g of nano fumed silica with a particle size of 12 nm to the reaction mixture and performing ultrasonic treatment for 30 min at a frequency of 50 kHz, so as to obtain the fluid for ink repulsive layer.

The ink for the graphic-text layer consists of 10% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (reactive black), and water in balance, based on the ink for the graphic-text layer. The performance parameters of the prepared printing plate are listed in Table 1.

### Preparation Comparative Example 1

A printing plate is prepared by the method as described in Preparation Example 1, but the difference is in that, during preparation of the fluid for the ink repulsive layer, the nano fumed silica is not added to the reaction mixture (i.e., the prepared fluid for ink repulsive layer contains no nano silica). The performance parameters of the prepared printing plate are listed in Table 1.

### Preparation Comparative Example 2

A printing plate is prepared by the method as described in Preparation Example 1, but the difference is in that, during preparation of the fluid for the ink repulsive layer, perfluoroethyl acrylate is not used and propyl methacrylate is added in an amount of 1.2 g. The performance parameters of the prepared printing plate are listed in Table 1.

### Preparation Example 2

A printing plate is prepared by the method as described in Preparation Example 1, but the difference is in that, propyl methacrylate is not used and perfluoroethyl acrylate is added in an amount of 1.2 g. The performance parameters of the prepared printing plate are listed in Table 1.

### Preparation Example 3

An aluminum plate is used as a substrate, which is not subject to roughened, but before use, it is subject to deoiling by soaking in 8% by weight sodium carbonate aqueous solution for 80 s, rinsing with water and then drying.

The fluid for the ink repulsive layer is applied by spin coater on one surface of the substrate at a speed of 4500 rpm in a coating amount of 2.8 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.3 g·m⁻² followed by solidified in air at 150° C. for 20 min to obtain the printing plate according to the present invention.

Wherein, the fluid for the ink repulsive layer is prepared by adding 1 g of perfluoroethyl acrylate and 0.2 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.1 g of nano fumed silica with a particle size of 20 nm to the reaction mixture and performing ultrasonic treatment for 30 min at a frequency of 80 kHz, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in name of BYK-331), 2% by weight dye (reactive black), and water in balance, based on the ink for the graphic-text layer. The performance parameters of the prepared printing plate are listed in Table 1.

### Preparation Example 4

An aluminum alloy plate is used as a substrate, which is not subject to roughened, but before use, it is subject to deoiling by soaking in 12% by weight monosodium phosphate aqueous solution for 120 s, rinsing with water and then drying.

The fluid for the ink repulsive layer is applied by spin coater on one surface of the substrate at a speed of 4500 rpm in a coating amount of 2.6 g·m⁻² followed by solidified in air at 200° C. for 20 min to obtain an aluminum alloy plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.5 g·m⁻² followed by solidified in air at 150° C. for 20 min to obtain the printing plate according to the present invention.

Wherein, the fluid for the ink repulsive layer is prepared by adding 1 g of perfluoroethyl acrylate and 0.2 g of propyl methacrylate in a three-neck flask under the protection of nitrogen, then adding 12 g of butanone and 0.05 g of azodiisobutyronitrile and taking reaction in nitrogen at 70° C. for 12 h; finally adding 0.15 g of nano fumed silica with a particle size of 30 nm to the reaction mixture and performing ultrasonic treatment for 30 min at a frequency of 50 kHz, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (reactive black), and water in balance, based on the ink for the graphic-text layer. The performance parameters of the prepared printing plate are listed in Table 1.

### Preparation Example 5

An aluminum plate is used as a substrate, which is not subject to roughened, but before use, it is subject to deoiling by soaking in 5% by weight sodium hydroxide aqueous solution for 120 s, rinsing with water and then drying.

The fluid for the ink repulsive layer is applied by spin coater on one surface of the substrate at a speed of 4500 rpm in a coating amount of 3.1 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.2 g·m⁻² followed by solidified in air at 150° C. for 20 min to obtain the printing plate according to the present invention.

Wherein, the fluid for the ink repulsive layer is prepared by adding 1.2 g of perfluoroethyl acrylate and 0.4 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.32 g of nano fumed silica with a particle size of 50 nm to the reaction mixture and performing ultrasonic treatment for 30 min at a frequency of 50 kHz, so as to obtain the fluid for the ink repulsive layer.

The ink for the graphic-text layer consists of 10% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (acid blue 9), and water in balance, based on the ink for the graphic-text layer. The performance parameters of the prepared printing plate are listed in Table 1.

### Preparation Example 6

A polycarbonate plate is used as a substrate, which is not subjected to roughening.

The fluid for the ink repulsive layer is applied by spin coater on one surface of the substrate at a speed of 4500 rpm in a coating amount of 2.9 g·m⁻² followed by solidified in air at 200° C. for 20 min to obtain a polycarbonate plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.5 g·m⁻² followed by solidified in air at 150° C. for 20 min to obtain the printing plate according to the present invention.

Wherein, the fluid for the ink repulsive layer is prepared by adding 1.4 g of perfluoroethyl acrylate and 0.6 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.5 g of nano fumed silica with a particle size of 30 nm to the reaction mixture and performing ultrasonic treatment for 30 min at a frequency of 50 kHz, so as to obtain the fluid for the ink repulsive layer.

The ink for the graphic-text layer consists of 10% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (basic brilliant blue), and water in balance, based on the ink for the graphic-text layer. The performance parameters of the prepared printing plate are listed in Table 1.

### Preparation Example 7

An aluminum plate is used as a substrate, which is not subject to roughening, but before use, it is subject to deoiling by soaking in 5% by weight sodium hydroxide and 5% by weight sodium bicarbonate mixed aqueous solution for 60 s, rinsing with water and then drying.

The fluid for the ink repulsive layer is applied by spin coater on one surface of the substrate at a speed of 4500 rpm in a coating amount of 3.3 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.7 g·m⁻² followed by solidified in air at 150° C. for 20 min to obtain the printing plate according to the present invention.

Wherein, the fluid for the ink repulsive layer is prepared by adding 1.6 g of perfluoroethyl acrylate and 0.8 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.72 g of nano fumed silica with a particle size of 100 nm to the reaction mixture and performing ultrasonic treatment for 30 min at a frequency of 50 kHz, so as to obtain the fluid for the ink repulsive layer.

The ink for the graphic-text layer consists of 10% by weight water soluble phenolic resin (purchased from Hengtai Chemical Corporation, Jining, China in a name of PF3211), 3% by weight organosilicone leveling agent (purchased from German BYK in a name of BYK-331), 2% by weight dye (reactive black), and water in balance, based on the ink for the graphic-text layer. The performance parameters of the prepared printing plate are listed in Table 1.

### Preparation Example 8

An aluminum plate is used as a substrate, which is not subject to roughening, but before use, it is subject to deoiling by soaking in 8% by weight sodium carbonate and 12% by weight sodium bicarbonate mixed aqueous solution for 150 s, rinsing with water and then drying.

The fluid for the ink repulsive layer is applied by spin coater on one surface of the substrate at a speed of 4500 rpm in a coating amount of 2.7 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.0 g·m⁻² followed by solidified in air at 150° C. for 20 min to obtain the printing plate according to the present invention.

Wherein, the fluid for the ink repulsive layer is prepared by adding 1.8 g of perfluoroethyl acrylate and 1 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.11 g of Si₃N₄ with a particle size of 50 nm to the reaction mixture and performing ultrasonic treatment for 30 min at a frequency of 50 kHz, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (reactive black), and water in balance, based on the ink for the graphic-text layer. The performance parameters of the prepared printing plate are listed in Table 1.

### Preparation Example 9

An aluminum plate is used as a substrate, which is not subject to roughening, but before use, it is subject to deoiling by soaking in 15% by weight sodium bicarbonate aqueous solution for 200 s, rinsing with water and then drying.

The fluid for the ink repulsive layer is applied by spin coater on one surface of the substrate at a speed of 4500 rpm in a coating amount of 3.2 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.5 g·m⁻² followed by solidified in air at 150° C. for 20 min to obtain the printing plate according to the present invention.

Wherein, the fluid for the ink repulsive layer is prepared by adding 1.6 g of 4-perfluoro(2-isopropyl-1,3-dimethyl-1-butenyl)oxy styrene and 0.8 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.19 g of Si₃N₄ with a particle size of 50 nm to the reaction mixture and performing ultrasonic treatment for 30 min at a frequency of 50 kHz, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (reactive black), and water in balance, based on the ink for the graphic-text layer. The performance parameters of the prepared printing plate are listed in Table 1.

### Preparation Example 10

A polypropylene plate is used as a substrate, which is not subjected to roughening.

The fluid for the ink repulsive layer is applied by spin coater on one surface of the substrate at a speed of 4500 rpm in a coating amount of 3.1 g·m⁻² followed by solidified in air at 200° C. for 20 min to obtain a polypropylene plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.8 g·m⁻² followed by solidified in air at 150° C. for 20 min to obtain the printing plate according to the present invention.

Wherein, the fluid for the ink repulsive layer is prepared by adding 1.6 g of N-allyl-perfluorobutyl sulfamide and 0.8 g of propyl methacrylate in a three-neck flask under the protection of nitrogen, then adding 12 g of butanone and 0.05 g of azodiisobutyronitrile and taking reaction in nitrogen at 65° C. for 12 h; finally adding 0.29 g of Si₃N₄ with a particle size of 100 nm to the reaction mixture and performing ultrasonic treatment for 30 min at a frequency of 50 kHz, so as to obtain the fluid for the ink repulsive layer.

The ink for the graphic-text layer consists of 10% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (reactive black), and water in balance, based on the ink for the graphic-text layer. The performance parameters of the prepared printing plate are listed in Table 1.

### Preparation Example 11

An aluminum plate is used as a substrate, which is not subject to roughening, but before use, it is subject to deoiling by soaking in 5% by weight sodium hydroxide aqueous solution for 150 s, rinsing with water and then drying.

The fluid for the ink repulsive layer is applied by spin coater on one surface of the substrate at a speed of 4500 rpm in a coating amount of 3.5 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.2 g·m⁻² followed by solidified in air at 150° C. for 20 min to obtain the printing plate according to the present invention.

Wherein, the fluid for the ink repulsive layer is prepared by adding 1.6 g of 4-perfluoro(2-isopropyl-1,3-dimethyl-1-butenyl)oxy styrene and 0.8 g of propyl methacrylate in a three-neck flask under the protection of nitrogen, then adding 12 g of butanone and 0.05 g of azodiisobutyronitrile and taking reaction in nitrogen at 65° C. for 24 h; finally adding 0.38 g of Si₃N₄ with a particle size of 150 nm and performing ultrasonic treatment for 30 min at a frequency of 50 kHz, so as to obtain the fluid for the ink repulsive layer.

The ink for the graphic-text layer consists of 20 wt % water soluble phenolic resin (purchased from Hengtai Chemical Corporation, Jining, China in a name of PF3211), 3 wt % organosilicone leveling agent (purchased from German BYK in a name of BYK-331), 2% dye (reactive black), and water in balance, based on the ink for the graphic-text layer. The performance parameters of the prepared printing plate are listed in Table 1.

### Preparation Example 12

An aluminum plate is used as a substrate, which is not subject to roughening, but before use, it is subject to deoiling by soaking in 10% by weight sodium phosphate aqueous solution for 60 s, rinsing with water and then drying.

The fluid for the ink repulsive layer is applied by spin coater on one surface of the substrate at a speed of 4500 rpm in a coating amount of 2.8 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.9 g·m⁻² followed by solidified in air at 150° C. for 20 min to obtain the printing plate according to the present invention.

Wherein, the fluid for the ink repulsive layer is prepared by adding 1.6 g of 4-perfluoro(2-isopropyl-1,3-dimethyl-1-butenyl)oxy styrene and 0.8 g of propyl methacrylate in a three-neck flask under the protection of nitrogen, then adding 12 g of butanone and 0.05 g of azodiisobutyronitrile and taking reaction in nitrogen at 65° C. for 36 h; finally adding 0.48 g of Si₃N₄ with a particle size of 30 nm to the reaction mixture and performing ultrasonic treatment for 30 min at a frequency of 50 kHz, so as to obtain the fluid for the ink repulsive layer.

The ink for the graphic-text layer consists of 10 wt % water soluble phenolic resin (purchased from Hengtai Chemical Corporation, Jining, China in a name of PF3211) and water in balance, based on the ink for the graphic-text layer. The performance parameters of the prepared printing plate are listed in Table 1.

### Preparation Example 13

An aluminum plate is used as a substrate, which is not subject to roughening, but before use, it is subject to deoiling by soaking in 10% by weight sodium hydroxide aqueous solution for 30 s, rinsing with water and then drying.

The fluid for the ink repulsive layer is applied by spin coater on one surface of the substrate at a speed of 4500 rpm in a coating amount of 3.6 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.3 g·m⁻² followed by solidified in air at 150° C. for 20 min to obtain the printing plate according to the present invention.

Wherein, the fluid for the ink repulsive layer is prepared by the method as described below.

Add 5 g of silane coupling agent vinyl trimethoxy silane A-171 to 100 g of acetone, then adding 1.5 g of nano fumed silica with a particle size of 12 nm, stir them evenly and perform ultrasonic treatment for 30 min at a frequency of 50 kHz; then filter the solution after ultrasonic treatment, collect the solid material; finally dry the collected solid material in air at 200° C. for 3 h, so as to obtain nano silica treated with coupling agent, and put it in a desiccator for future use.

Add 2 g of 4-perfluoro (2-isopropyl-1,3-dimethyl-1-butenyl)oxy styrene in a three-neck flask under the protection of nitrogen, then add 10 g of N-methyl pyrrolidone and 0.5 g of prepared nano silica treated with coupling agent, stir them at room temperature (25° C.) for 1 h, raise temperature to 65° C., add 0.3 g of azodiisobutyronitrile and take reaction in nitrogen at 65° C. for 12 h, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of grade BYK-331), 2% by weight dye (reactive black), and water in balance, based on the ink for the graphic-text layer. The performance parameters of the prepared printing plate are listed in Table 1.

### Preparation Example 14

A printing plate is prepared by the method as described in Preparation Example 13, but difference is in that, the nano silica is not treated with coupling agent, that is, the nano silica is the nano silica used as raw material in the coupling agent treatment step of Preparation Example 13. The performance parameters of the prepared printing plate are listed in Table 1.

### Preparation Example 15

A printing plate is prepared by the method as described in Preparation Example 13, but difference is in that, 4-perfluoro(2-isopropyl-1,3-dimethyl-1-butenyl)oxy styrene is replaced with an equal weight of perfluoroethyl acrylate. The performance parameters of the prepared printing plate are listed in Table 1.

### Preparation Example 16

A printing plate is prepared by the method as described in Preparation Example 13, but difference is in that, 4-perfluoro(2-isopropyl-1,3-dimethyl-1-butenyl)oxy styrene is replaced with an equal weight of (N-methyl-perfluoroheptyl-amido)ethyl acrylate. The performance parameters of the prepared printing plate are listed in Table 1.

### Preparation Example 17

A printing plate is prepared by the method as described in Preparation Example 13, but difference is in that, 4-perfluoro(2-isopropyl-1,3-dimethyl-1-butenyl)oxy styrene is replaced with an equal weight of (N-methyl-perfluorooctyl-sulfonamido)ethyl acrylate. The performance parameters of the prepared printing plate are listed in Table 1.

### Preparation Example 18

A printing plate is prepared by the method as described in Preparation Example 13, but difference is in that, 4-perfluoro(2-isopropyl-1,3-dimethyl-1-butenyl)oxy styrene is replaced with an equal weight of 4-trifluoromethyl styrene. The performance parameters of the prepared printing plate are listed in Table 1.

### Preparation Example 19

An aluminum plate is used as a substrate, which is not subject to roughening, but before use, it is subject to deoiling by soaking in 1% by weight sodium hydroxide aqueous solution for 60 s, rinsing with water and then drying.

The fluid for the ink repulsive layer is applied by spin coater on one surface of the substrate at a speed of 4500 rpm in a coating amount of 3.5 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.8 g·m⁻² followed by solidified in air at 150° C. for 20 min to obtain the printing plate according to the present invention.

Wherein, the fluid for the ink repulsive layer is prepared by the method as described below.

Add 5 g of silane coupling agent vinyl tri(β-methoxyethoxy) silane A-172 to 100 g of acetone, then add 1.5 g of Si₃N₄ with a particle size of 150 nm, stir them evenly and perform ultrasonic treatment for 30 min at a frequency of 100 kHz, then filter the solution after ultrasonic treatment, collect the solid material; finally dry the collected solid material in air at 200° C. for 3 h, so as to obtain nano silica treated with coupling agent, and put it in a desiccator for future use.

Add 2 g of 4-perfluoro(2-isopropyl-1,3-dimethyl-1-butenyl)oxy styrene in a three-neck flask under the protection of nitrogen, then add 10 g of butanone and 0.5 g of prepared Si₃N₄ treated with coupling agent, stir them at room temperature (25° C.) for 1 h, raise temperature to 65° C., add 0.3 g of azodiisobutyronitrile and take reaction in nitrogen at 65° C. for 12 h, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of grade BYK-331), 3% by weight dye (basic brilliant blue), and water in balance, based on the ink for the graphic-text layer. The performance parameters of the prepared printing plate are listed in Table 1.

### Preparation Example 20

An aluminum plate is used as a substrate, which is not subject to roughening, but before use, it is subject to deoiling by soaking in 5% by weight sodium phosphate and 5% by weight monosodium phosphate mixed aqueous solution for 100 s, rinsing with water and then drying.

The fluid for the ink repulsive layer is applied by spin coater on one surface of the substrate at a speed of 4500 rpm in a coating amount of 3.5 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 1.6 g·m⁻² followed by solidified in air at 150° C. for 20 min to obtain the printing plate according to the present invention.

Wherein, the fluid for the ink repulsive layer is prepared by the method as described below.

Add 5 g of silane coupling agent vinyl triethoxy silane A-151 to 100 g of acetone, then add 1.5 g of nano fumed silica with a particle size of 50 nm, stir them evenly and perform ultrasonic treatment for 30 min at a frequency of 50 kHz; then filter the solution after ultrasonic treatment, collect the solid material, dry the collected solid material in air at 200° C. for 3 h, so as to obtain nano silica treated with coupling agent, and put it in a desiccator for future use.

Add 2.5 g of 4-perfluoro(2-isopropyl-1,3-dimethyl-1-butenyl)oxy styrene in a three-neck flask under the protection of nitrogen, then add 10 g of butanone and 0.5 g of prepared nano silica treated with coupling agent, stir them at room temperature (25° C.) for 1 h, raise temperature to 65° C., add 0.3 g of azodiisobutyronitrile and take reaction in nitrogen at 65° C. for 12 h, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of grade BYK-331), 2% by weight dye (basic brilliant blue), and water in balance, based on the ink for the graphic-text layer. The performance parameters of the prepared printing plate are listed in Table 1.

### Preparation Example 21

An aluminum plate is used as a substrate, which is not subject to roughening, but before use, it is subject to deoiling by soaking in 10% by weight sodium phosphate aqueous solution for 60 s, rinsing with water and then drying.

The fluid for the ink repulsive layer is applied by spin coater on one surface of the substrate at a speed of 4500 rpm in a coating amount of 2.9 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.5 g·m⁻² followed by solidified in air at 150° C. for 20 min to obtain the printing plate according to the present invention.

Wherein, the fluid for the ink repulsive layer is prepared by the method as described below.

Add 5 g of silane coupling agent vinyl triethoxy silane A-151 to 100 g of acetone, then add 1.5 g of nano fumed silica with a particle size of 100 nm, stir them evenly and perform ultrasonic treatment for 30 min at a frequency of 80 kHz, then filter the solution after ultrasonic treatment, collect the solid material, dry the collected solid material in air at 200° C. for 3 h, so as to obtain nano silica treated with coupling agent, and put it in a desiccator for future use.

Add 3 g of 4-perfluoro(2-isopropyl-1,3-dimethyl-1-butenyl)oxy styrene in a three-neck flask under the protection of nitrogen, then add 10 g of butanone and 0.5 g of prepared nano silica treated with coupling agent, stir them at room temperature (25° C.) for 1 h, raise temperature to 65° C., add 0.3 g of azodiisobutyronitrile and take reaction in nitrogen at 65° C. for 12 h, so as to obtain the fluid for the ink repulsive layer.

The ink for the graphic-text layer consists of 10% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (basic brilliant blue), and water in balance, based on the ink for the graphic-text layer. The performance parameters of the prepared printing plate are listed in Table 1.

### Preparation Example 22

An aluminum plate is used as a substrate, which is not subject to roughening, but before use, it is subject to deoiling by soaking in 1 wt % sodium hydroxide and 5 wt % sodium phosphate aqueous solution for 30 s, rinsing with water and then drying.

The fluid for the ink repulsive layer is applied by spin coater on one surface of the substrate at a speed of 4500 rpm in a coating amount of 3.7 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.3 g·m⁻² followed by solidified in air at 150° C. for 20 min to obtain the printing plate according to the present invention.

Wherein, the fluid for the ink repulsive layer is prepared by the method as described below.

Add 5 g of silane coupling agent vinyl triethoxy silane A-151 to 100 g of acetone, then add 1.5 g of nano fumed silica with a particle size of 15 nm, stir them evenly and perform ultrasonic treatment for 30 min at a frequency of 60 kHz; then filter the solution after ultrasonic treatment, collect the solid material, dry the collected solid material in air at 200° C. for 3 h, so as to obtain nano silica treated with coupling agent, and put it in a desiccator for future use.

Add 2.5 g of 4-perfluoro(2-isopropyl-1,3-dimethyl-1-butenyl)oxy styrene in a three-neck flask under the protection of nitrogen, then add 15 g of butanone and 0.5 g of prepared nano silica treated with coupling agent, stir them at room temperature (25° C.) for 1 h, raise temperature to 65° C., add 0.3 g of azodiisobutyronitrile and take reaction in nitrogen at 65° C. for 12 h, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (basic brilliant blue), and water in balance, based on the ink for the graphic-text layer. The performance parameters of the prepared printing plate are listed in Table 1.

### Preparation Example 23

An aluminum plate is used as a substrate, which is not subject to roughening, but before use, it is subject to deoiling by soaking in 8% by weight sodium carbonate aqueous solution for 180 s, rinsing with water and then drying.

The fluid for ink repulsive layer is applied by spin coater on one surface of the substrate at a speed of 4500 rpm in a coating amount of 3.9 g·m⁻² followed by solidified in air at 200° C. for 20 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.0 g·m⁻² followed by solidified in air at 150° C. for 20 min to obtain the printing plate according to the present invention.

Wherein, the fluid for the ink repulsive layer is prepared by the method as described below.

Add 5 g of silane coupling agent vinyl triethoxy silane A-151 to 100 g of acetone, then add 1.5 g of nano fumed silica with a particle size of 100 nm, stir them evenly and perform ultrasonic treatment for 30 min at a frequency of 100 kHz; then filter the solution after ultrasonic treatment, collect the solid material, dry the collected solid material in air at 200° C. for 3 h, so as to obtain nano silica treated with coupling agent, and put it in a desiccator for future use.

Add 2.5 g of 4-perfluoro(2-isopropyl-1,3-dimethyl-1-butenyl)oxy styrene in a three-neck flask under the protection of nitrogen, then add 20 g of butanone and 0.5 g of prepared nano silica treated with coupling agent, stir them at room temperature (25° C.) for 1 h, raise temperature to 65° C., add 0.3 g of azodiisobutyronitrile and take reaction in nitrogen at 65° C. for 12 h, so as to obtain the fluid for the ink repulsive layer.

The ink for the graphic-text layer consists of 10% by weight water soluble phenolic resin (purchased from Hengtai Chemical Corporation, Jining, China in a name of PF3211), 2% by weight organosilicone leveling agent (purchased from German BYK in a name of grade BYK-331), 2% by weight dye (basic brilliant blue), and water in balance, based on the ink for the graphic-text layer. The performance parameters of the prepared printing plate are listed in Table 1.

### Preparation Example 24

An aluminum plate is used as a substrate, which is not subject to roughening, but before use, it is subject to deoiling by soaking in 2% by weight sodium hydroxide aqueous solution for 30 s, rinsing with water and then drying.

The fluid for the ink repulsive layer is applied by spin coater on one surface of the substrate at a speed of 4500 rpm in a coating amount of 3.2 g·m⁻² followed by solidified in air at 180° C. for 30 min to obtain an aluminum plate with an ink repulsive layer. The water contact angle of the ink repulsive layer is determined and surface energy is calculated.

The ink for the graphic-text layer is sprayed to the surface of ink repulsive layer by ink-jet printing method in a coating amount of 2.2 g·m⁻² followed by solidified in air at 180° C. for 30 min to obtain the printing plate according to the present invention.

Wherein, the fluid for the ink repulsive layer is prepared by the method as described below.

Add 5 g of silane coupling agent vinyl triethoxy silane A-151 to 100 g of acetone, then add 1.5 g of silicon carbide with a particle size of 30 nm, stir them evenly and perform ultrasonic treatment for 30 min at a frequency of 50 kHz; then filter the solution after ultrasonic treatment, collect the solid material, dry the collected solid material in air at 180° C. for 4 h, so as to obtain silicon carbide treated with coupling agent, and put it in a desiccator for future use.

Add 2.5 g of 4-perfluoro(2-isopropyl-1,3-dimethyl-1-butenyl)oxy styrene in a three-neck flask under the protection of nitrogen, then add 30 g of cyclohexanone and 0.5 g of prepared silicon carbide treated with coupling agent, stir them at room temperature (25° C.) for 1 h, raise temperature to 65° C., add 0.4 g of dibenzoyl peroxide and take reaction in nitrogen at 65° C. for 24 h, so as to obtain the fluid for the ink repulsive layer.

The ink for the graphic-text layer consists of 20% by weight water soluble phenolic resin (purchased from Hengtai Chemical Corporation, Jining, China in a name of PF3211), 2% by weight organosilicone leveling agent (purchased from German BYK in a name of BYK-331), 2% by weight dye (basic brilliant blue), and water in balance, based on the ink for the graphic-text layer.

The performance parameters of the prepared printing plate are listed in Table 1.

TABLE 1

| | | | Elastic |
|---|---|---|---|
| | Surface | Roughness Ra | modulus |
| No. | energy (J · m⁻²) | (μm) | (N · m⁻²) |
| Preparation Example 1 | 29 | 0.36 | 5.0 × 10⁵ |
| Comparative Preparation | 35 | 0.30 | 5.8 × 10⁵ |
| Example 1 | | | |
| Comparative Preparation | 33 | 0.38 | 5.9 × 10⁵ |
| Example 2 | | | |
| Preparation Example 2 | 32 | 0.40 | 5.5 × 10⁵ |
| Preparation Example 3 | 27 | 0.41 | 5.4 × 10⁵ |
| Preparation Example 4 | 29 | 0.43 | 5.1 × 10⁵ |
| Preparation Example 5 | 26 | 0.46 | 5.5 × 10⁵ |
| Preparation Example 6 | 24 | 0.49 | 5.7 × 10⁵ |
| Preparation Example 7 | 28 | 0.44 | 5.5 × 10⁵ |
| Preparation Example 8 | 30 | 0.41 | 5.6 × 10⁵ |
| Preparation Example 9 | 29 | 0.53 | 5.2 × 10⁵ |
| Preparation Example 10 | 20 | 0.57 | 6.6 × 10⁵ |
| Preparation Example 11 | 26 | 0.45 | 6.1 × 10⁵ |
| Preparation Example 12 | 27 | 0.51 | 6.0 × 10⁵ |
| Preparation Example 13 | 25 | 0.58 | 5.3 × 10⁵ |
| Preparation Example 14 | 30 | 0.55 | 6.3 × 10⁵ |
| Preparation Example 15 | 29 | 0.52 | 5.8 × 10⁵ |
| Preparation Example 16 | 32 | 0.49 | 5.0 × 10⁵ |
| Preparation Example 17 | 29 | 0.45 | 5.9 × 10⁵ |
| Preparation Example 18 | 31 | 0.53 | 5.8 × 10⁵ |
| Preparation Example 19 | 29 | 0.60 | 5.9 × 10⁵ |
| Preparation Example 20 | 27 | 0.51 | 6.2 × 10⁵ |
| Preparation Example 21 | 24 | 0.56 | 5.8 × 10⁵ |
| Preparation Example 22 | 21 | 0.60 | 6.9 × 10⁵ |
| Preparation Example 23 | 27 | 0.54 | 6.0 × 10⁵ |
| Preparation Example 24 | 26 | 0.49 | 5.2 × 10⁵ |

Preparation Examples 25 to 31 are used to prepare water-based printing ink.

### Preparation Example 25

### (1) Prepare Monomer a

Add phenol into a three-neck flask, add water as much as four times of the weight of phenol to dissolve it under stirring, add formaldehyde (in 37% by weight aqueous solution) as much as two times of the mole number of phenol, stir them evenly, add sodium hydroxide equal to 10% by weight of the total solution weight, take reaction under stirring at room temperature (25° C.) for 12 h, add dilute hydrochloric acid to neutralize the solution to neutral after the reaction completes and extract monomer a (i.e., 2,6-dimethylol phenol) by ethyl acetate.

### (2) Prepare Hyperbranched Methylol Phenol a

Make monomer a into 10% by weight ethanol solution, add ammonium hydroxide (in a concentration of 20% by weight) equal to 4% of the total solution weight as catalyst, take reaction at 60° C. for 6 h and remove the solvent to get hyperbranched polymer A (i.e., hyperbranched methylol phenol) with a number average molecular weight of 1100 and a degree of branching 80%.

The reaction process is shown as below.

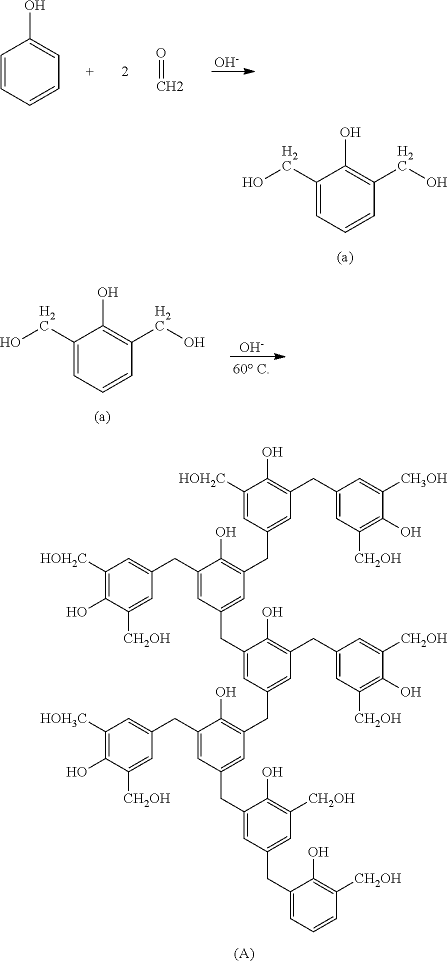

### (3) Prepare Water-Based Printing Ink

Put 65 parts by weight of the hyperbranched polymer A prepared above in a three-roller machine, add 10 parts by weight of nano calcium carbonate with a particle size of 50 nm, 15 parts by weight of yellow organic dye and 10 parts by weight of water at 600 r/min and grind the powder till the fineness is smaller than 10 μm, so as to obtain water-based printing ink with a properties as shown in Table 2.

### Preparation Example 26

### (1) Prepare Monomer b

Put tri(4-hydroxy-phenyl) methane

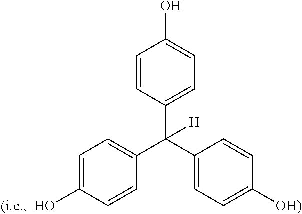

in a three-neck flask, add water as much as one time of the weight of tri(4-hydroxy-phenyl) methane, and tetrahydrofuran as much as three times of the weight of tri(4-hydroxy-phenyl) methane, stir and dissolve it, then add epichlorohydrin equimolar to tri(4-hydroxy-phenyl) methane, stir them evenly, then add sodium hydroxide equal to 5% by weight of the total solution weight, stir them at room temperature (25° C.) for 6 h, carry out reduced pressure distillation after the reaction ends, and extract monomer b

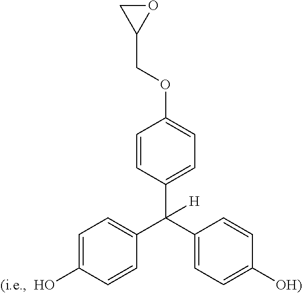

by ethyl acetate.

### (2) Prepare Hyperbranched Polyhydroxy Epoxide B

Make monomer b into 10% by weight ethanol solution, add sodium hydroxide equal to 1% by weight of the total solution weight as catalyst, and take reaction at 60° C. for 4 h to get hyperbranched polymer B (i.e., hyperbranched polyhydroxy epoxide) with a number average molecular weight of 2450 and a degree of branching of 60%.

The reaction process is shown as below.

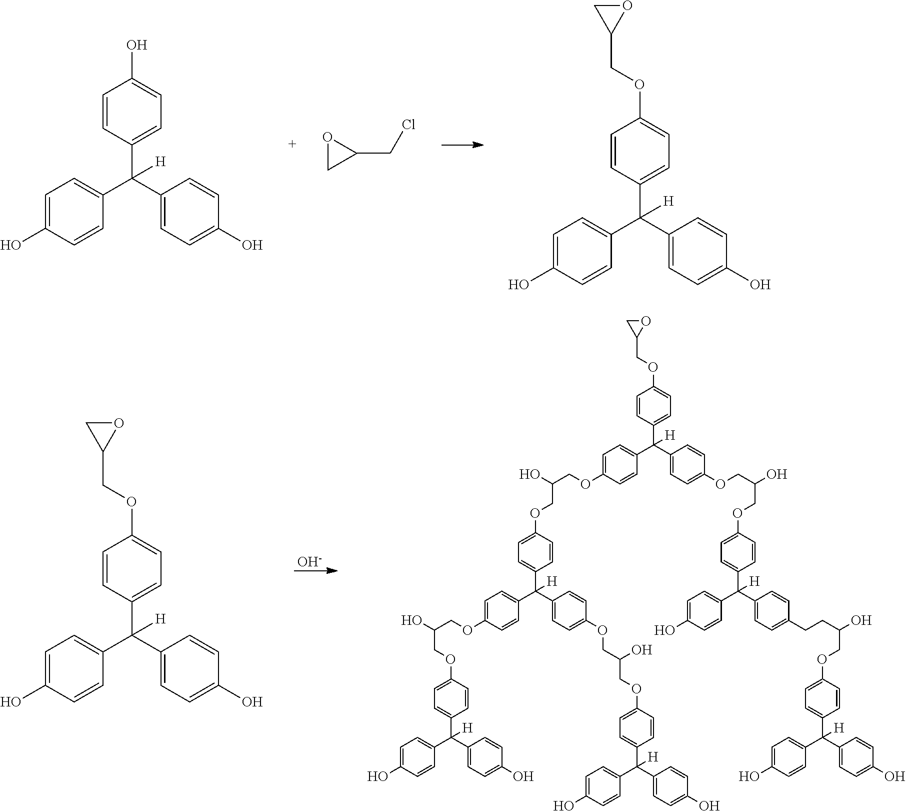

### (3) Prepare Water-Based Printing Ink

Put 70 parts by weight of the hyperbranched polymer B prepared above in a three-roller machine, add 5 parts by weight of nano magnesium silicate with a particle size of 50 nm, 15 parts by weight of blue organic dye and 10 parts by weight of water at 600 r/min and grind the powder till the fineness is smaller than 10 μm, so as to obtain water-based printing ink with a properties as shown in Table 2.

### Preparation Example 27

### (1) Prepare Hyperbranched Polyamide C

Put 3,5-dicarboxy aniline in a three-neck flask, add water as much as one time of weight of 3,5-dicarboxy aniline and ethanol as much as three times of weight of 3,5-dicarboxy aniline, stir and dissolve them, then heat the solution to 60° C., react at this temperature under stirring for 6 h, carry out reduced pressure distillation after the reaction compelets, and extract hyperbranched polymer C (i.e., hyperbranched polyamide) with a number average molecular weight of 1020 and degree of branching of 75% by ethyl acetate.

The reaction process is shown as below.

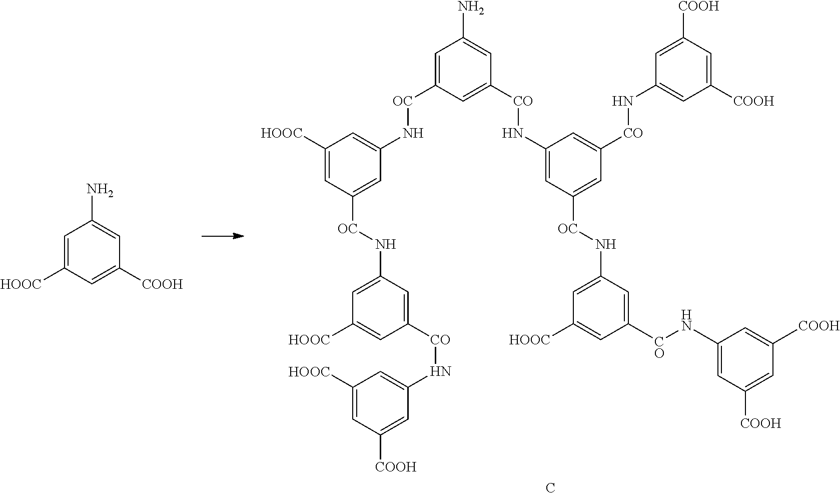

### (2) Prepare Water-Based Printing Ink

Put 60 parts by weight of the hyperbranched polymer C prepared above in a three-roller machine, add 10 parts by weight of nano silica with a particle size of 20 nm, 20 parts by weight of red organic dye and 10 parts by weight of water, and grind the powder till the fineness is smaller than 10 μm, so as to obtain water-based printing ink with a properties as shown in Table 2.

### Preparation Example 28

Put 40 parts by weight of hyperbranched polymer A and 40 parts by weight of hyperbranched polymer B in a three-roller machine, add 5 parts by weight of nano magnesium silicate with a particle size of 100 nm, 10 parts by weight of black organic dye and 5 parts by weight of water at 600 r/min and grind the powder till the fineness is smaller than 10 μm, so as to obtain water-based printing ink with a properties as shown in Table 2.

### Preparation Example 29

Put 35 parts by weight of hyperbranched polymer B and 35 parts by weight of hyperbranched polymer C in a three-roller machine, add 5 parts by weight of nano magnesium silicate with a particle size of 100 nm, 15 parts by weight of black organic dye and 10 parts by weight of water at 600 r/min and grind the powder till the fineness is smaller than 10 μm, so as to obtain water-based printing ink with a properties as shown in Table 2.

### Preparation Example 30

Put 40 parts by weight of hyperbranched polymer A and 40 parts by weight of hyperbranched polymer C in a three-roller machine, add 5 parts by weight of nano magnesium silicate with a particle size of 50 nm, 5 parts by weight of blue organic dye and 10 parts by weight of water at 600 r/min and grind the powder till the fineness is smaller than 10 μm, so as to obtain water-based printing ink with a properties as shown in Table 2.

### Preparation Example 31

Put 25 parts by weight of hyperbranched polymer A, 25 parts by weight of hyperbranched polymer B and 25 parts by weight of hyperbranched polymer C in a three-roller machine, add 7 parts by weight of nano magnesium silicate with a particle size of 200 nm, 15 parts by weight of blue organic dye and 3 parts by weight of water at 600 r/min and grind the powder till the fineness is smaller than 10 μm, so as to obtain water-based printing ink with a properties as shown in Table 2.

TABLE 2

| | | Preparation Example | | | | | | | | | | | | | | Detection |
|---|---|---|---|---|---|---|---|---|---|---|---|---|---|---|---|---|
| | | 25 | | 26 | | 27 | | 28 | | 29 | | 30 | | 31 | | method |
| Detection | Appearance | Yellow | | Blue | | Red | | Black | | Yellow | | Blue | | Red | | Visual |
| items | | paste | | paste | | paste | | paste | | paste | | paste | | paste | | inspection |
| | Fineness | <10 | um | <10 | um | <10 | um | <10 | um | <10 | um | <10 | um | <10 | um | Double- |
| | | | | | | | | | | | | | | | | groove |
| | | | | | | | | | | | | | | | | fineness |
| | | | | | | | | | | | | | | | | gauge |
| | Adhesive | Not fall | | Not fall | | Not fall | | Not fall | | Not fall | | Not fall | | Not fall | | Tear by |
| | force | off | | off | | off | | off | | off | | off | | off | | using 3M |
| | | | | | | | | | | | | | | | | adhesive |
| | | | | | | | | | | | | | | | | tape |
| | Viscosity | 14 | Pa · s | 17 | Pa · s | 15 | Pa · s | 20 | Pa · s | 14 | Pa · s | 16 | Pa · s | 15 | Pa · s | Rheometer, |
| | | | | | | | | | | | | | | | | 25° C. |
| | Fluidity | 27 | mm | 30 | mm | 28 | mm | 30 | mm | 30 | mm | 27 | mm | 27 | mm | Fluidity |
| | | | | | | | | | | | | | | | | tester |

| | | | | | | | | |
|---|---|---|---|---|---|---|---|---|
| Odor | odorless | odorless | odorless | odorless | odorless | odorless | odorless | Smell by |
| | | | | | | | | nose |

Examples 1 to 24 are intended to describe the planographic printing system and planographic printing method according to the present invention.

Examples 1 to 24 adopt the planographic printing system as shown in FIG. 2, and the difference is in that the planographic printing plate is respectively prepared in Preparation Examples 1 to 24 by using the water-based printing ink as listed in Table 3 for printing. The pressrun of the planographic printing plate as well as the resolution and dot reproducibility of the obtained presswork is listed in Table 3. The dot reproducibility is determined by the method specified in CYT 5-1999 Requirements and Inspection Method of the Quality of Planographic Presswork and pressrun is determined by Heidelberg four-color press.

TABLE 3

| | Water-based | Resolution | Dot reproducibility | Pressrun |
|---|---|---|---|---|
| No. | printing ink | (pdi) | (%) | (10,000) |
| Example 1 | Preparation | 600 | 99 | 7 |
| Comparative | Example 25 | 600 | 99 | 3 |
| example 1 | | | | |
| Comparative | | 400 | 92 | 5 |
| example 2 | | | | |
| Example 2 | | 600 | 95 | 7 |
| Example 3 | Preparation | 600 | 99 | 8 |
| | Example 26 | | | |
| Example 4 | Preparation | 600 | 99 | 7 |
| | Example 27 | | | |
| Example 5 | Preparation | 600 | 99 | 8 |
| | Example 28 | | | |
| Example 6 | Preparation | 600 | 99 | 8 |
| | Example 29 | | | |
| Example 7 | Preparation | 600 | 99 | 7 |
| | Example 30 | | | |
| Example 8 | Preparation | 600 | 99 | 7 |
| | Example 31 | | | |
| Example 9 | Preparation | 600 | 99 | 9 |
| | Example 25 | | | |
| Example 10 | Preparation | 600 | 99 | 9 |
| | Example 26 | | | |
| Example 11 | Preparation | 600 | 99 | 9 |
| | Example 27 | | | |
| Example 12 | Preparation | 600 | 99 | 9 |
| | Example 28 | | | |
| Example 13 | Preparation | 600 | 99 | 10 |
| Example 14 | Example 29 | 600 | 99 | 8 |
| Example 15 | | 600 | 98 | 7 |
| Example 16 | | 600 | 99 | 7 |
| Example 17 | | 600 | 98 | 8 |
| Example 18 | | 600 | 99 | 10 |
| Example 19 | Preparation | 600 | 99 | 9 |
| | Example 30 | | | |
| Example 20 | Preparation | 600 | 99 | 10 |
| | Example 31 | | | |
| Example 21 | Preparation | 600 | 99 | 9 |
| | Example 31 | | | |
| Example 22 | Preparation | 600 | 99 | 10 |
| | Example 31 | | | |
| Example 23 | Preparation | 600 | 99 | 10 |
| | Example 31 | | | |
| Example 24 | Preparation | 600 | 99 | 10 |
| | Example 31 | | | |

The result of Table 3 proves the planographic printing system according to the present invention can realize printing by water-based printing ink, the pressrun of the planographic printing plate is high, and the obtained presswork has good printing quality with high resolution and high dot reproducibility.

What is claimed is:

1. A planographic printing system, comprising an ink supply device, a planographic printing plate and a printing stock, the planographic printing plate gains ink from the ink supply device, so as to transfer graphic-text information from the planographic printing plate to surface of the printing stock, the planographic printing plate comprises a substrate, an ink repulsive layer attaching to the surface of the substrate and a graphic-text layer attaching to partial surface of the ink repulsive layer, the ink repulsive layer comprises fluoropolymer and silicon-containing nano-particle dispersed in the fluoropolymer, the fluoropolymer comprises fluorine-containing structural unit and optional acrylate-based structural unit.

2. The planographic printing system according to claim 1, wherein relative to 100 parts of the fluoropolymer, the silicon-containing nano-particle is in a content of 1-150 parts by weight.

3. The planographic printing system according to claim 1, wherein based on the fluoropolymer, the fluorine-containing structural unit is in a content of 50-100% by weight, the acrylate-based structural unit is in a content of 0-50% by weight.

4. The planographic printing system according to claim 3, wherein the fluorine-containing structural unit is derived from fluorine-containing monomer containing ethylenically unsaturated double bond, and the fluorine-containing monomer containing ethylenically unsaturated double bond is at least one selected from the group consisting of perfluoroalkyl (meth)acrylate, perfluoroamido alkyl (meth)acrylate, perfluorosulfonamido alkyl (meth)acrylate, fluoroalkyl-substituted styrene, fluoroalkyl-alkenyloxy-styrene, N-allyl-perfluoroalkyl-sulfamide and allyl perfluoroalkyl-alkenyl ether;
the acrylate-based structural unit is derived from acrylate-based monomer, and the acrylate-based monomer is at least one selected from the group consisting of methyl methacrylate, ethyl methacrylate, propyl methacrylate, butyl methacrylate, isobutyl methacrylate, amyl methacrylate, hexyl methacrylate, 2-ethyl hexyl methacrylate, nonyl methacrylate, decyl methacrylate, dodecyl methacrylate, phenyl methacrylate, benzyl methacrylate, ethyoxy methyl methacrylate, methoxy ethyl methacrylate, propoxy ethyl methacrylate, butoxy ethyl methacrylate, ethoxy propyl methacrylate and isobornyl methacrylate.

5. The planographic printing system according to claim 4, wherein the fluorine-containing monomer containing ethylenically unsaturated double bond is at least one selected from the group consisting of perfluoroethyl acrylate, 4-perfluoro(2-isopropyl-1,3-dimethyl-1-butenyl)oxy styrene, N-allyl-perfluorobutyl-sulfamide, (N-methyl-perfluoroheptyl-sulfonamido)ethyl acrylate, (N-methyl-perfluorooctyl-sulfonamido)ethyl acrylate and 4-trifluoromethyl styrene.

6. The planographic printing system according to claim 1, wherein the silicon-containing nano-particle has a particle size in range of 10 nm to 200 nm;
the silicon-containing nano-particle is at least one selected from the group consisting of silica, silicon nitride and silicon carbide.

7. The planographic printing system according to claim 1, wherein surface of the silicon-containing nano-particle is modified by coupling agent.

8. The planographic printing system according to claim 1, wherein the ink repulsive layer is coated on surface of the substrate in a coating amount of 2-5 g·m-2, and the graphic-text layer is coated on surface of the ink repulsive layer in a coating amount of 0.5-3 g·m-2;
the ink repulsive layer has a surface energy in range of 15-40 J·m-2, has a roughness Ra in range of 0.3 μm to 0.8 μm and has an elastic modulus in range of 3×105N m-2 to 10×105N m-2.

9. The planographic printing system according to claim 1, wherein the substrate is aluminum substrate, aluminum alloy substrate, steel substrate, polycarbonate substrate, polyester substrate or polyolefin substrate;
the graphic-text layer is formed by water-based platemaking ink, the water-based platemaking ink comprises water soluble phenolic resin, optional leveling agent, optional dye and water, based on the water-based platemaking ink, the water soluble phenolic resin is in a content of 5-60% by weight, the leveling agent is in a content of 0-10% by weight, the dye is in a content of 0-10% by weight and the water is in a content of 20-95% by weight.

10. The planographic printing system according to claim 1, wherein the system further comprises a rolling platform and a plate cylinder,
the rolling platform is for supporting the printing stock and has one or two selected from the group consisting of heating part and adsorption part, the adsorption part is used to fix the printing stock to the surface of rolling platform, the heating part is used to heat the printing stock received ink, so as to dry the ink on the surface of the printing stock;
the planographic printing plate is placed on the periphery of the plate cylinder, the plate cylinder further has a temperature control part, which measures the temperature of the planographic printing plate, and heats or cools the planographic printing plate based on the measured temperature, thereby regulating the temperature on the surface of the planographic printing plate.

11. A planographic printing method, which is performed in a planographic printing system, the planographic printing system comprises an ink supply device, a planographic printing plate and a printing stock, the planographic printing plate comprises a substrate, an ink repulsive layer attaching to at least one surface of the substrate and a graphic-text layer attaching to partial surface of the ink repulsive layer, the ink repulsive layer comprises fluoropolymer and silicon-containing nano-particle dispersed in the fluoropolymer, the fluoropolymer comprises fluorine-containing structural unit and optional acrylate-based structural unit,
the method comprises delivering water-based printing ink to the planographic printing plate through the ink supply device, and transferring graphic-text information on the graphic-text layer of the planographic printing plate to the surface of the printing stock.

12. The planographic printing method according to claim 11, wherein relative to 100 parts of the fluoropolymer, the silicon-containing nano-particle is in a content of 1-150 parts by weight.

13. The planographic printing method according to claim 11, wherein based on the fluoropolymer, the fluorine-containing structural unit is in a content of 50-100% by weight, the acrylate-based structural unit is in a content of 0-50% by weight;
the fluorine-containing structural unit is derived from fluorine-containing monomer containing ethylenically unsaturated double bond, and the fluorine-containing monomer containing ethylenically unsaturated double bond is at least one selected from the group consisting of perfluoroalkyl (meth)acrylate, perfluoroamido alkyl (meth)acrylate, perfluorosulfonamido alkyl (meth)acrylate, fluoroalkyl-substituted styrene, fluoroalkyl-alkenyloxy-styrene, N-allyl-perfluoroalkyl-sulfamide and allyl perfluoroalkyl-alkenyl ether;
the acrylate-based structural unit is derived from acrylate-based monomer, and the acrylate-based monomer is at least one selected from the group consisting of methyl methacrylate, ethyl methacrylate, propyl methacrylate, butyl methacrylate, isobutyl methacrylate, amyl methacrylate, hexyl methacrylate, 2-ethyl hexyl methacrylate, nonyl methacrylate, decyl methacrylate, dodecyl methacrylate, phenyl methacrylate, benzyl methacrylate, ethyoxy methyl methacrylate, methoxy ethyl methacrylate, propoxy ethyl methacrylate, butoxy ethyl methacrylate, ethoxy propyl methacrylate and isobornyl methacrylate.

14. The planographic printing method according to claim 13, wherein the fluorine-containing monomer containing ethylenically unsaturated double bond is at least one selected from the group consisting of perfluoroethyl acrylate, 4-perfluoro(2-isopropyl-1,3-dimethyl-1-butenyl)oxy styrene, N-allyl-perfluorobutyl-sulfamide, (N-methyl-perfluoroheptyl-sulfonamido) ethyl acrylate, (N-methyl-perfluorooctyl-sulfonamido) ethyl acrylate and 4-trifluoromethyl styrene.

15. The planographic printing method according to claim 11, wherein the silicon-containing nano-particle has a particle size in range of 10 nm to 200 nm;
the silicon-containing nano-particle is at least one selected from the group consisting of silica, silicon nitride and silicon carbide.

16. The planographic printing method according to claim 11, wherein surface of the silicon-containing nano-particle is modified by coupling agent.

17. The planographic printing method according to claim 11, wherein the ink repulsive layer is coated on surface of the substrate in a coating amount of 2-5 g·m-2, and the graphic-text layer is coated on surface of the ink repulsive layer in a coating amount of 0.5-3 g·m-2;
the ink repulsive layer has a surface energy in range of 15-40 J·m-2, has a roughness Ra in range of 0.3 μm to 0.8 μm and has an elastic modulus in range of 3×105N m-2 to 10×105N m-2.

18. The planographic printing method according to claim 11, wherein the substrate is aluminum substrate, aluminum alloy substrate, steel substrate, polycarbonate substrate, polyester substrate or polyolefin substrate;
the graphic-text layer is formed by water-based platemaking ink, the water-based platemaking ink comprises water soluble phenolic resin, optional leveling agent, optional dye and water, based on the water-based platemaking ink, the water soluble phenolic resin is in a content of 5-60% by weight, the leveling agent is in a content of 0-10% by weight, the dye is in a content of 0-10% by weight and the water is in a content of 20-95% by weight.

19. The planographic printing method according to claim 11, wherein the system further comprises a rolling platform and a plate cylinder,
the rolling platform is for supporting the printing stock and has one or two selected from the group consisting of heating part and adsorption part, the adsorption part is used to fix the printing stock to the surface of rolling platform, the heating part is used to heat the printing stock received ink, so as to dry the ink on the surface of the printing stock;
the planographic printing plate is placed on the periphery of the plate cylinder, the plate cylinder further has a temperature control part, which measures the temperature of the planographic printing plate, and heats or cools the planographic printing plate based on the measured temperature, thereby regulating the temperature on the surface of the planographic printing plate.

20. The printing method according to claim 11, wherein the water-based printing ink comprises water-soluble hyperbranched polymer, filler, dye and water, based on the water-based printing ink, the water-soluble hyperbranched polymer is in a content of 30-85% by weight, the filler is in a content of 2-20% by weight, the dye is in a content of 5-20% by weight,
the water-soluble hyperbranched polymer is at least one selected from the group consisting of hyperbranched methylol phenol, hyperbranched hydroxy epoxide and hyperbranched polyamide,
the hyperbranched methylol phenol has a number average molecular weight in range of 1000-50000 and a degree of branching in range of 10-90%; the hyperbranched polyhydroxy epoxide has a number average molecular weight in range of 1000-100000 and a degree of branching in range of 10-90%; the hyperbranched polyamide has a number average molecular weight in range of 1000-50000 and a degree of branching in range of 10-90%;
the filler is at least one selected from the group consisting of nano silica, nano calcium carbonate and nano magnesium silicate, and the filler has a particle size of 10-800 nm;
the dye is organic dye.
